(19) United States
(12) Patent Application Publication
(10) Pub. No.: US 2026/0243890 A1
(43) Pub. Date: Aug. 20, 2026

(54) APPARATUS AND METHOD FOR CONTROLLING RADAR SYSTEM

(71) Applicant: HL KLEMOVE CORPORATION, Incheon (KR)

(72) Inventor: JUNYOUNG KIM, Incheon (KR)

(73) Assignee: HL KLEMOVE CORPORATION, Incheon (KR)

(21) Appl. No.: 19/324,726

(22) Filed: Sep. 10, 2025

(30) Foreign Application Priority Data
Feb. 14, 2025 (KR) 10-2025-0019185

(51) Int. Cl. G01S 13/931

(52) U.S. Cl. CPC G01S 13/931; G01S 2013/932; G01S 2013/9322

(57) ABSTRACT

The present disclosure relates to an apparatus and method for controlling a radar system of a vehicle. A vehicle radar system control apparatus according to the present disclosure detects an ignition status and a speed of the vehicle, and controls an operation of a radar system including a radar sensor of the vehicle based on a combination of the ignition status and the speed. This enables optimization of energy consumption of the radar system, thereby improving fuel efficiency or reducing battery consumption of the vehicle.

### CROSS-REFERENCE TO RELATED APPLICATION

The present application claims priority under 35 U.S.C. § 119(a) to Korean patent application number 10-2025-0019185 filed on Feb. 14, 2025, in the Korean Intellectual Property Office, the entire disclosure of which is incorporated by reference herein.

### BACKGROUND

### Technical Field

The present disclosure relates to a control technology for a radar system for vehicles, and more particularly, to a control technology for optimizing power consumption of the radar system.

### Description of Related Art

As driver assistance devices and systems such as autonomous driving and Advanced Driver Assistance Systems (ADAS) continue to evolve, the importance of sensors used therein—such as cameras, radars, and lidars—is also increasing.

These sensors are used to collect information about the surroundings of a vehicle and either autonomously drive the vehicle or assist the driver in avoiding hazardous situations. As a result, not only the types but also the number of sensors used in vehicles are inevitably increasing.

However, since these sensors often operate continuously to collect surrounding information for safety, the amount of power they consume has become significant. In particular, radar sensors tend to consume a large amount of energy, which negatively affects the fuel efficiency of internal combustion engine vehicles and the battery life of electric vehicles.

The inventors of the present disclosure have conducted research to solve the problem of power consumption in radar systems of conventional technologies. Through extensive efforts, the present disclosure has been completed to provide an apparatus and method for controlling a radar system, which can minimize the power consumption of the radar system by controlling the power consumption of the radar sensor not simply based on whether the vehicle is driving but also based on the driving speed of the vehicle and the surrounding environment.

### BRIEF SUMMARY

The present disclosure is directed to providing an apparatus and method for controlling a radar system, which can minimize the power consumption of the radar system.

Meanwhile, other aspects not specified of the present disclosure will be additionally contemplated within the range that can be easily inferred from the following detailed description and effects thereof.

An apparatus for controlling a radar system according to the present disclosure may include a memory configured to store one or more instructions; and a processor configured to execute the one or more instructions stored in the memory, wherein the processor is configured to detect an ignition status and a speed of the vehicle, and control an operation of the radar system including a radar sensor of the vehicle based on a combination of the ignition status and the speed.

The processor may be configured to control an output of the radar sensor in proportion to the detected speed when the vehicle is in an ignition-on state.

The processor may be configured to switch the radar system to a sleep mode as a standby mode when the detected speed is zero.

The processor may be configured to control the radar sensor to operate at a maximum output when the detected speed is equal to or greater than a first threshold value.

The processor may be configured to control the radar sensor to operate at a minimum output while the radar system processes data detected by the radar sensor after the radar sensor has operated at the maximum output for target detection.

The processor may be configured to control the radar sensor to operate at less than the maximum output for target detection when the detected speed is less than a first threshold value, and then control the radar system to switch to a sleep mode in which the output of the radar sensor is minimized and power consumption of the radar system is minimized.

When the vehicle is in an ignition-off state, the processor may be configured to switch the radar system to a deep sleep mode in which the output of the radar sensor is zero and power consumption of the radar system is minimized.

The deep sleep mode may consume less power than a sleep mode in which the output of the radar sensor is minimized and power consumption of the radar system is minimized.

The processor may be configured to control the radar sensor to operate at less than a maximum output for target detection when the detected speed is not zero and a driving environment identified by a camera sensor or a location sensor is an urban environment.

The processor may be configured to control the radar sensor to operate at a maximum output for target detection when the detected speed is not zero and a driving environment identified by a camera sensor or a location sensor is not an urban environment.

A method for controlling a radar system according to another embodiment of the present disclosure may include detecting an ignition status of the vehicle; detecting a speed of the vehicle; and controlling a radar system including a radar sensor of the vehicle based on a combination of the ignition status and the speed.

The controlling the radar system may include controlling an output of the radar sensor in proportion to the detected speed when the vehicle is in an ignition-on state.

The controlling the radar system may include switching the radar system to a sleep mode as a standby mode when the detected speed is zero.

The controlling the radar system may include controlling the radar sensor to operate at a maximum output when the detected speed is equal to or greater than a first threshold value.

The controlling the radar system may include controlling the radar sensor to operate at a minimum output while the radar system processes data detected by the radar sensor after the radar sensor has operated at the maximum output for target detection.

The controlling the radar system may include controlling the radar sensor to operate at less than a maximum output for target detection when the detected speed is less than a first threshold value, and then controlling the radar system to switch to a sleep mode in which the output of the radar sensor is minimized and power consumption of the radar system is minimized.

When the vehicle is in an ignition-off state, the controlling the radar system may include switching the radar system to a deep sleep mode in which the output of the radar sensor is zero and power consumption of the radar system is minimized.

The deep sleep mode may consume less power than a sleep mode in which the output of the radar sensor is minimized and power consumption of the radar system is minimized.

The controlling the radar system may include controlling the radar sensor to operate at less than a maximum output for target detection when the detected speed is not zero and a driving environment identified by a camera sensor or a location sensor is an urban environment.

The controlling the radar system may include controlling the radar sensor to operate at a maximum output for target detection when the detected speed is not zero and a driving environment identified by a camera sensor or a location sensor is not an urban environment.

According to the present disclosure, by optimizing power consumption of the radar system, it is possible to achieve improved fuel efficiency in internal combustion engine vehicles or increased driving range in electric vehicles.

In the meantime, even if there is an effect not explicitly specified herein, it is added that the effects expected by the technical features of the present disclosure and described effects and provisional effects thereof in the following specification are regarded as described in the specification of the present disclosure.

### BRIEF DESCRIPTION OF THE SEVERAL VIEWS OF THE DRAWINGS

FIG. 1 is a schematic structural diagram of a radar system control apparatus according to a preferred embodiment of the present disclosure.

FIG. 2 illustrates power consumption according to tasks of a radar system in accordance with a preferred embodiment of the present disclosure.

FIG. 3 illustrates power consumption according to tasks of a radar system in accordance with a preferred embodiment of the present disclosure.

FIG. 4 illustrates power consumption according to tasks of a radar system in accordance with a preferred embodiment of the present disclosure.

FIG. 5 illustrates a method for controlling a radar system according to a preferred embodiment of the present disclosure.

FIG. 6 illustrates a method for controlling a radar system according to a preferred embodiment of the present disclosure.

FIG. 7 is a diagram illustrating a computing environment including a computing apparatus.

The accompanying drawings are exemplified by reference for understanding the technical spirit of the present disclosure, and the scope of the present disclosure is not limited thereto.

### DETAILED DESCRIPTION

Hereinafter, specific embodiments according to an embodiment of the present disclosure will be described with reference to the drawings. The following detailed description is provided to aid in a comprehensive understanding of the methods, apparatuses, and/or systems described in the present specification. However, this is merely exemplary, and the present disclosure is not limited thereto.

In describing the embodiments of the present disclosure, detailed descriptions of related known technologies will be omitted when it is determined that such descriptions may unnecessarily obscure the gist of the embodiments. The terms used below are defined in consideration of the functions within the present disclosure and may vary depending on user, operator intention, or customary usage or the like. Therefore, the definitions should be interpreted based on the overall content of this specification. The terminology used in the detailed description is intended merely to describe exemplary embodiments and should not be construed as limiting. Unless explicitly stated otherwise, expressions in the singular form include the plural meaning as well. In the present description, expressions such as “comprise,” “include,” or “provide” are intended to indicate the presence of stated features, numbers, steps, operations, elements, components, or combinations thereof, and should not be interpreted as excluding the possibility of the presence or addition of one or more other features, numbers, steps, operations, elements, components, or combinations thereof. In addition, terms such as “unit,” “device,” “means,” “part,” “member,” “module,” “block.” etc., which are described in the specification, mean a unit of a comprehensive configuration that performs at least one function or operation, which may be implemented in hardware or software, or in a combination of hardware and software.

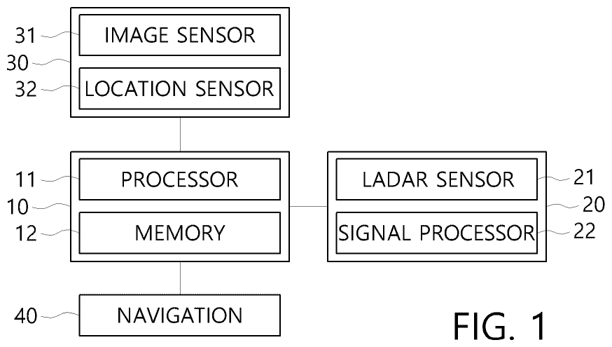

FIG. 1 is a schematic structural diagram of a vehicle radar system control apparatus according to a preferred embodiment of the present disclosure.

The vehicle radar system control apparatus 10 according to the present disclosure may include at least one processor 11 and a memory 12.

The memory 12 may store instructions, data structures, and program code readable by the processor 11. In some embodiments, at least the operations performed by the processor 11 may be implemented by executing instructions or code of a program stored in the memory 12.

The memory 12 may include a flash memory type, a hard disk type, a multimedia card micro type, or a card-type memory (e.g., SD or XD memory), and may include non-volatile memory such as ROM (Read-Only Memory), EEPROM (Electrically Erasable Programmable Read-Only Memory), PROM (Programmable Read-Only Memory), magnetic memory, magnetic disks, or optical disks, and volatile memory such as RAM (Random Access Memory) or SRAM (Static Random Access Memory).

The memory 12 may store one or more instructions or programs that the vehicle radar system control apparatus 10 may use to control power of a radar system 20 including a radar sensor, depending on the situation.

The processor 11 controls the overall operations of the vehicle radar system control apparatus 10. For example, by executing one or more instructions stored in the memory 12, the processor 11 may control overall operations of the vehicle radar system control apparatus 10 for controlling power of the radar system 20.

The processor 11 may include, for example, at least one of a central processing unit (CPU), a microprocessor, a graphics processing unit (GPU), an application-specific integrated circuit (ASIC), a digital signal processor (DSP), a digital signal processing device (DSPD), a programmable logic device (PLD), a field programmable gate array (FPGA), an application processor, a neural processing unit (NPU), or a processor dedicated to artificial intelligence designed with a hardware architecture specialized for processing AI models, but is not limited thereto.

The vehicle radar system control apparatus 10 may be connected to the radar system 20 to transmit and receive information.

The radar system 20 includes a radar sensor 21 and a signal processor 22.

The radar sensor 21 may include a transmitter and a receiver.

The signal processor may convert detection information received from the receiver into a digital signal. The signal processor is not limited to merely converting the detection information into a digital signal, and may perform various possible transformations such as signal filtering, FFT conversion, and the like.

The vehicle radar system control apparatus 10 may be connected to a location sensing module 30 to transmit and receive information.

The location sensing module 30 may include sensors for acquiring information related to the location of the vehicle. Here, the information related to the vehicle's location may include not only the physical location of the vehicle but also environmental information associated with the location of the vehicle. For example, the location-related information may include whether the surrounding area is densely populated with buildings or detection targets such as people, or whether the vehicle is on a highway or a general road.

The location sensing module 30 may include an image sensor 31 and a location sensor 32. For example, the image sensor 31 may be a component of a camera, and the location sensor 32 may be a sensor that processes GPS information.

Location-related information of the vehicle may be determined by the processor based on a combination of environmental information received from the navigation system along with data from the image sensor 31 or the location sensor 32.

The method for generating the location-related information is not necessarily limited to the examples described above.

In one embodiment of the present disclosure, the processor 11 adjusts the output of the radar sensor and the power of the radar system 20 including the radar sensor based on the ignition status and speed of the vehicle.

The processor 11 receives the ignition status and speed of the vehicle for this purpose.

The ignition status and vehicle speed may be received from the vehicle's Electronic Control Unit (ECU) through Control Area Network (CAN) communication or the like, but are not limited thereto.

The processor 11 may determine whether the ignition of the vehicle is in the ON state. If the ignition is in the OFF state, the processor 11 controls the radar system 20 to enter a first sleep mode. The first sleep mode may also be referred to as a deep sleep mode.

In the case of the radar system 20, it may be implemented using components such as a Radio Frequency Integrated Circuit (RFIC), and the processor 11 controls the RFIC to minimize its power consumption.

The control condition for the first sleep mode is when the vehicle is in a stationary state and the ignition is also OFF. In the first sleep mode, the processor 11 controls the output of the radar sensor 21 to be zero and allows only the minimum power required for wake-up of the radar system 20 to be used.

When the ignition is in the ON state, the processor 11 adjusts power consumption by varying the control method of the radar system 20 according to the driving situation.

The processor 11 may determine whether the vehicle is in motion while the ignition is ON. If the vehicle is not in motion, the processor 11 controls the radar system 20 to enter a second sleep mode.

Unlike the first sleep mode, the second sleep mode may be performed in a state where the vehicle is ready to start at any time. The control condition for the second sleep mode is when the ignition is ON and the vehicle is not in motion. In the second sleep mode, the output of the radar sensor 21 is turned OFF, and only standby power may be supplied to the radar system 20. Accordingly, power consumption in the first sleep mode is lower than in the second sleep mode.

When the vehicle is in motion, the processor 11 adjusts the power consumption by varying the control method of the radar system 20 according to the vehicle's speed or driving environment.

The processor 11 determines whether the speed of the moving vehicle exceeds a first set speed (S25), and if it does, sets the output of the radar sensor 21 to a first level. The first level may indicate the maximum output of the radar sensor 21. In this case, the power consumption of the radar system 20 may be at its maximum.

When the vehicle is moving at a relatively high speed, the approach speed of an object ahead is also high. In this case, it is necessary to detect objects located at a relatively long distance in front of the vehicle, and thus the processor 11 may set the output of the radar sensor 21 to its maximum level. Additionally, in such a case, the radar sensor 21 may be controlled to have a shorter detection cycle, which results in increased power consumption of the radar system 20.

Meanwhile, even when the vehicle is traveling at high speed, if a target is detected by the radar sensor 21, data processing for the detected target is required. Accordingly, the processor 11 may reduce the output of the radar sensor 21 to a minimum level while the radar system 20 processes the data detected by the radar sensor 21. Therefore, the power consumption of the radar system 20 can be reduced during the data processing period.

When the vehicle speed is less than or equal to the first set speed and greater than the second set speed, the processor 11 may adjust the output level of the radar sensor 21 to a second level. The second level may be a predefined level between the minimum output and maximum output of the radar sensor 21. This control based on the second level may be referred to as a normal mode. When the vehicle speed is within the above range, the approach speed of a target is relatively low, and therefore it may be sufficient even without detecting targets at a long distance. The first set speed is greater than the second set speed.

In some embodiments, the processor 11 may adjust the output level of the radar sensor 21 in proportion to the vehicle's speed.

Even in the normal mode, the processor 11 may minimize the output of the radar sensor 21 while processing the detected data in order to reduce power consumption.

When the vehicle is traveling at a low speed equal to or less than the second set speed, the processor 11 may control the radar system 20 to enter a sleep mode for a certain period of time. Specifically, the processor 11 controls the tasks of the radar system 20 by dividing them into a target detection task and a sleep mode task. The cycle in which the target detection task and the sleep mode task are alternately switched is defined as a switching cycle. The detection cycle of the radar sensor 21 described above refers to how frequently sensing signals are transmitted and received during the execution of the target detection task, and is distinguished from the switching cycle, which refers to the cycle at which the target detection task itself is suspended and the system transitions to the sleep mode.

The processor 11 may further reduce the energy consumption of the radar system 20 by controlling the radar system 20 to enter the sleep mode after target detection and data processing performed by the radar system 20 are completed, until the next target detection task begins. As another control method, the processor 11 may operate the radar system 20 in the sleep mode for a predetermined period of time after completing the target detection task and data processing, and then perform the target detection task again at the second level.

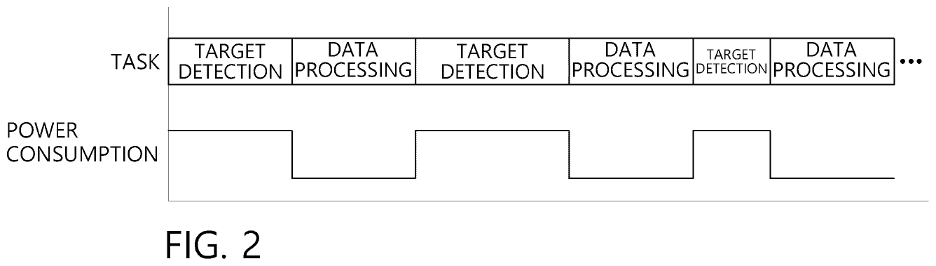

FIG. 2 illustrates power consumption according to tasks of a radar system 20 in accordance with a preferred embodiment of the present disclosure.

When a target is detected during the target detection task performed by the radar sensor 21, the processor 11 performs data processing through the signal processor 22 and may control the radar system 20 to minimize the output of the radar sensor 21 during the data processing period. The control of minimizing the output of the radar sensor 21 during data processing may be referred to as a data processing mode.

The task switching illustrated in FIG. 2 may be performed at uniform time intervals. That is, data processing may be performed periodically based on the detection information itself, regardless of whether an actual object (target) is detected. In this case, the switching cycle between the target detection task and the data processing task may be constant.

According to such a control method, since power consumption during data processing is reduced compared to power consumption during target detection, the total power consumption can be reduced.

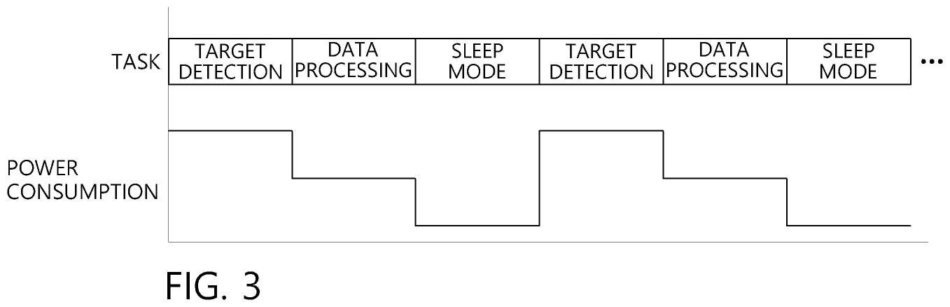

FIG. 3 illustrates power consumption according to tasks of a radar system 20 in accordance with a preferred embodiment of the present disclosure.

The processor 11 may control the radar system 20 to enter the sleep mode for a preset period of time either when a target is detected through the target detection task or after completing data processing following a transition to the data processing mode. According to such a combined control method, power consumption can be further reduced compared to high-speed driving conditions or compared to cases in which only the data processing mode is executed in parallel with the target detection task in an environment where the vehicle speed is below the first set speed and above the second set speed.

The processor 11 may adjust the power consumption of the radar system 20 not only based on the vehicle's speed but also by using environmental information around the vehicle.

The processor 11 may identify surrounding environmental information related to the vehicle's location by using information received from the camera sensor 31 or the location sensor 32, or by using such information in combination with navigation information 40.

For example, it is possible to recognize geographical features such as buildings on the driving path based on a front image received by the camera sensor 31, or to determine the surrounding environment from the map based on the current location information received by the location sensor 32.

The processor 11 controls the power of the radar system 20, including the radar sensor 21, according to the identified surrounding environment.

The processor 11 may determine whether the current location corresponds to a preset first environment based on location information. The first environment may be preset, for example, as an environment where it is necessary to detect surrounding targets more frequently, such as an area with a high density of buildings, a region with heavy pedestrian traffic, or a congested traffic area.

For example, in a densely built-up urban environment, where targets are often detected at close range, the output of the radar sensor 21 may be adjusted to the second level corresponding to the normal mode. In this case, the radar sensor 21 may be controlled to perform target detection more frequently by setting the detection cycle to a first cycle.

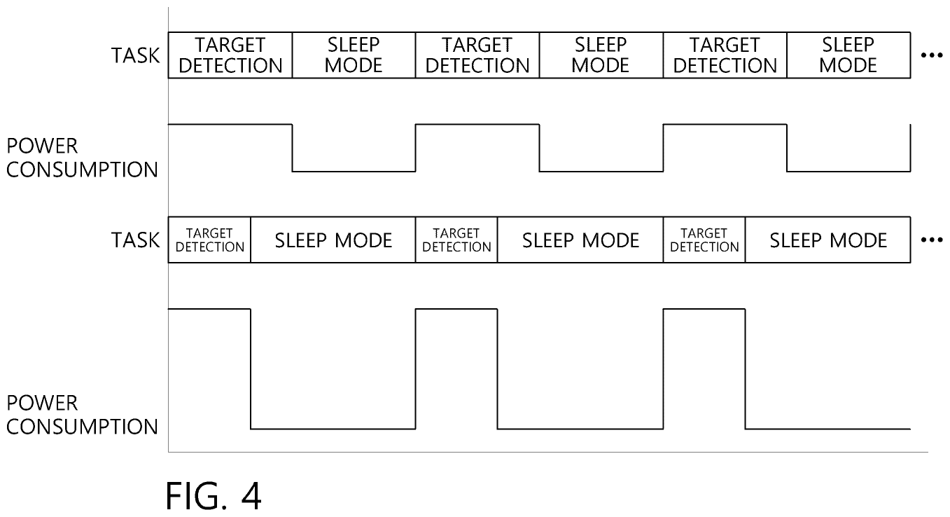

In a modified embodiment, the processor 11 may control the radar system 20 to alternately perform a detection task, in which targets are detected at the second output level, and an idle period, in which the system operates in the sleep mode. The task and power consumption relationship under such control is illustrated in the upper portion of FIG. 4. In a densely built-up urban environment, the processor 11 may control the system so that the detection task occupies more operation time than the idle period.

The processor 11 may determine whether the current location corresponds to a preset second environment based on location information. The second environment may be preset, for example, as an environment where surrounding targets need to be detected less frequently, such as a highway with relatively few surrounding vehicles, an area with low pedestrian traffic, or a region with relatively few surrounding obstacles.

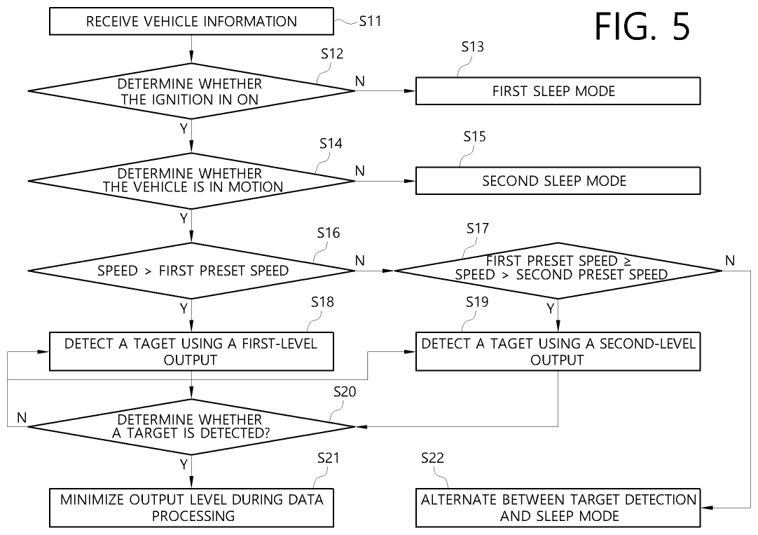

Conversely, in an environment without surrounding obstacles, such as a highway outside an urban area, the output of the radar sensor 21 may be adjusted to the maximum level or to a level higher than the second level for target detection. In this case, since the frequency of target appearance may be lower, the detection cycle of the radar sensor 21 may be reduced to a second cycle, and as a result, despite the increased output of the radar sensor 21, the average power consumption over time may be comparable to or even lower than that of the lower output level. The first cycle is greater than the second cycle. This means that sensing signals are transmitted and received more frequently in the first cycle than in the second cycle. The task and power consumption relationship under such control is illustrated in the lower portion of FIG. 4. To elaborate further, the output level of the radar sensor 21 may increase in proportion to the collision risk (or vehicle speed), and the detection cycle may increase in proportion to the number of surrounding obstacles. Here, the collision risk does not necessarily have to be determined based on the vehicle speed and may instead be predetermined based solely on the characteristics of the location information. For example, a highway may be considered to have a higher collision risk than a general road. FIG. 5 is a schematic flowchart of a vehicle radar system control method according to a preferred embodiment of the present disclosure.

The vehicle radar system control method according to the present disclosure may be performed by a vehicle radar system control apparatus 10 including at least one processor and a memory.

To control the radar system 20, information about the vehicle is received (S11).

The vehicle information includes at least one of the ignition status and the vehicle speed and may be received from the vehicle's ECU or the like.

The processor 11 determines whether the ignition is ON based on the received vehicle information (S12).

If the ignition is OFF, the processor 11 may control the radar system 20 to enter the first sleep mode (S13).

If the ignition is ON, the processor 11 determines whether the vehicle is in motion (S14).

If the vehicle is not in motion (e.g., the vehicle is stopped), the processor 11 may control the radar system 20 to enter the second sleep mode (S15).

As described above, the first sleep mode consumes less energy than the second sleep mode.

The processor 11 determines whether the vehicle speed exceeds a first set speed (S16).

If the vehicle speed exceeds the first set speed, the processor 11 adjusts the output of the radar sensor 21 to a first level (S18). The processor 11 determines whether the radar sensor 21 has detected a target (S20). If a target is detected by the radar sensor 21, the processor 11 adjusts the output level of the radar sensor 21 to a minimum level during data processing performed by the signal processor 22 (S21). Once data processing is completed, the processor 11 may control the radar sensor 21 to resume target detection at the first output level (S18).

If the vehicle speed is less than or equal to the first set speed, the processor 11 further determines whether the speed exceeds a second set speed (S17).

If the vehicle speed is less than or equal to the first set speed and greater than the second set speed, the processor 11 adjusts the output of the radar sensor 21 to a second level (S19). The processor 11 determines whether the radar sensor 21 has detected a target (S20). If a target is detected by the radar sensor 21, the processor 11 adjusts the output level of the radar sensor 21 to a minimum level during data processing performed by the signal processor 22 (S21). Once data processing is completed, the processor 11 may control the radar sensor 21 to resume target detection at the second output level (S19).

If the vehicle speed is less than or equal to the second set speed, the processor 11 controls the radar system 20 to alternately perform the target detection task and the sleep mode task (S22). Although not illustrated in the drawing, in this case as well, if a target is detected during the target detection mode, the system may switch to data processing to minimize the output of the radar sensor 21, and then return to the target detection mode or transition to the sleep mode.

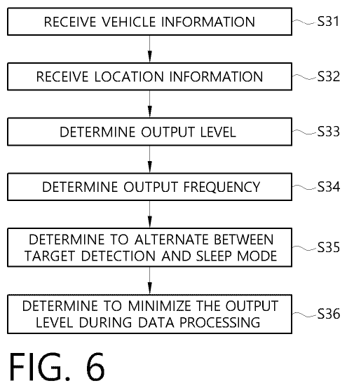

FIG. 6 illustrates a method for controlling a radar system according to a preferred embodiment of the present disclosure.

The processor 11 may receive vehicle information (S31). The vehicle information includes at least one of ignition ON/OFF status information and vehicle speed information.

The processor 11 may receive location information of the vehicle (S32).

The order in which the processor 11 receives the vehicle information and the location information may vary, and the processor 11 may receive only one of the two.

Based on at least one of the vehicle information and the location information, the processor 11 may perform at least one of the following: determining the output level of the radar sensor 21 (S33); determining the detection cycle of the radar sensor 21 during a target detection task (S34); determining whether to alternate between the target detection task and the sleep mode task (S35); and determining whether to minimize the output of the radar sensor 21 during data processing (S36). These determinations may be performed in various ways, such as sequentially, in a different order, or in parallel by selecting one or more of them.

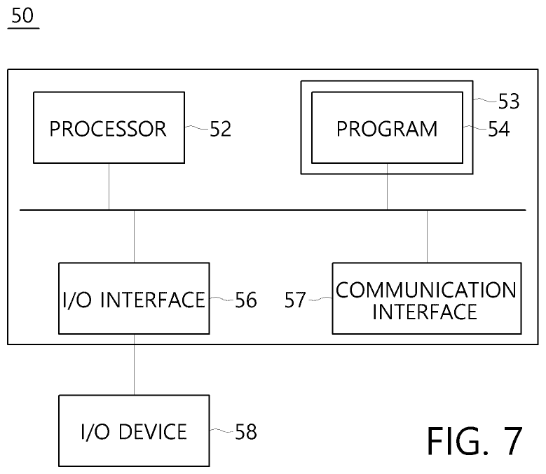

FIG. 7 is a diagram for describing a computing environment including a computing apparatus according to another preferred embodiment of the present disclosure.

In the illustrated embodiment, each component may have functions and capabilities different from those described below, and additional components not described below may also be included. The illustrated computing environment 50 includes a computing apparatus 51 and may perform the vehicle radar system 20 control method shown in FIG. 4. In an embodiment, the computing apparatus 51 may be one or more components included in the vehicle radar system control apparatus 20 shown in FIG. 1.

The computing apparatus 51 includes at least one processor 52, a non-transitory computer-readable storage medium 53, and a communication bus 55. The processor 52 may cause the computing apparatus 51 to operate according to the exemplary embodiments described above. For example, the processor 52 may execute one or more programs 54 stored in the computer-readable storage medium 53. The one or more programs 54 may include one or more computer-executable instructions, and when executed by the processor 52, the computer-executable instructions may be configured to cause the computing apparatus 51 to perform operations according to the exemplary embodiments.

The communication bus 55 interconnects various other components of the computing apparatus 51, including the processor 52 and the computer-readable storage medium 53.

The computing apparatus 51 may also include one or more input/output (I/O) interfaces 56 that provide interfaces for one or more input/output devices 58, and one or more communication interfaces 57. The input/output interface 56 and the communication interface 57 are connected to the communication bus 55. The input/output device 58 may be connected to other components of the computing apparatus 51 via the input/output interface 56. Exemplary input/output devices 58 may include input devices such as pointing devices (e.g., a mouse or a trackpad), keyboards, touch input devices (e.g., a touchpad or a touchscreen), voice or sound input devices, various types of sensor devices, and/or image capturing devices, and output devices such as display devices, printers, speakers, and/or network cards. The exemplary input/output device 58 may be included inside the computing apparatus 51 as one component constituting the computing apparatus 51, or may be a separate device distinguished from the computing apparatus 51 and connected thereto.

As described above, according to the vehicle radar system control apparatus and method of the present disclosure, power consumption of the vehicle radar system can be controlled based on the driving situation of the vehicle, thereby improving the energy efficiency of an internal combustion engine vehicle or an electric vehicle and enabling a longer driving range.

While the present disclosure has been described in detail with reference to representative embodiments, it will be understood by those skilled in the art that various modifications and equivalent other embodiments may be possible based on the present disclosure. Accordingly, the true technical scope of the present disclosure should be defined by the spirit of the appended claims.

1. An apparatus for controlling a radar system of a vehicle, comprising:
a memory configured to store one or more instructions; and
a processor configured to execute the one or more instructions stored in the memory,
wherein the processor is configured to:
detect an ignition status and a speed of the vehicle, and
control an operation of the radar system including a radar sensor of the vehicle based on a combination of the ignition status and the speed.

2. The apparatus of claim 1, wherein the processor is configured to control an output of the radar sensor in proportion to the detected speed when the vehicle is in an ignition-on state.

3. The apparatus of claim 2, wherein the processor is configured to switch the radar system to a sleep mode as a standby mode when the detected speed is zero.

4. The apparatus of claim 1, wherein the processor is configured to control the radar sensor to operate at a maximum output when the detected speed is equal to or greater than a first threshold value.

5. The apparatus of claim 4, wherein the processor is configured to control the radar sensor to operate at a minimum output while the radar system processes data detected by the radar sensor after the radar sensor has operated at the maximum output for target detection.

6. The apparatus of claim 1, wherein the processor is configured to control the radar sensor to operate at less than the maximum output for target detection when the detected speed is less than a first threshold value, and then control the radar system to switch to a sleep mode in which the output of the radar sensor is minimized and power consumption of the radar system is minimized.

7. The apparatus of claim 1, wherein, when the vehicle is in an ignition-off state, the processor is configured to switch the radar system to a deep sleep mode in which the output of the radar sensor is zero and power consumption of the radar system is minimized.

8. The apparatus of claim 7, wherein the deep sleep mode consumes less power than a sleep mode in which the output of the radar sensor is minimized and power consumption of the radar system is minimized.

9. The apparatus of claim 1, wherein the processor is configured to control the radar sensor to operate at less than a maximum output for target detection when the detected speed is not zero and a driving environment identified by a camera sensor or a location sensor is an urban environment.

10. The apparatus of claim 1, wherein the processor is configured to control the radar sensor to operate at a maximum output for target detection when the detected speed is not zero and a driving environment identified by a camera sensor or a location sensor is not an urban environment.

11. A method for controlling a radar system of a vehicle, the method being performed by a processor executing one or more instructions stored in a memory, the method comprising:
detecting an ignition status of the vehicle;
detecting a speed of the vehicle; and
controlling a radar system including a radar sensor of the vehicle based on a combination of the ignition status and the speed.

12. The method of claim 11, wherein the controlling the radar system comprises controlling an output of the radar sensor in proportion to the detected speed when the vehicle is in an ignition-on state.

13. The method of claim 12, wherein the controlling the radar system comprises switching the radar system to a sleep mode as a standby mode when the detected speed is zero.

14. The method of claim 11, wherein the controlling the radar system comprises controlling the radar sensor to operate at a maximum output when the detected speed is equal to or greater than a first threshold value.

15. The method of claim 14, wherein the controlling the radar system comprises controlling the radar sensor to operate at a minimum output while the radar system processes data detected by the radar sensor after the radar sensor has operated at the maximum output for target detection.

16. The method of claim 11, wherein the controlling the radar system comprises controlling the radar sensor to operate at less than a maximum output for target detection when the detected speed is less than a first threshold value, and then controlling the radar system to switch to a sleep mode in which the output of the radar sensor is minimized and power consumption of the radar system is minimized.

17. The method of claim 11, wherein, when the vehicle is in an ignition-off state, the controlling the radar system comprises switching the radar system to a deep sleep mode in which the output of the radar sensor is zero and power consumption of the radar system is minimized.

18. The method of claim 17, wherein the deep sleep mode consumes less power than a sleep mode in which the output of the radar sensor is minimized and power consumption of the radar system is minimized.

19. The method of claim 11, wherein the controlling the radar system comprises controlling the radar sensor to operate at less than a maximum output for target detection when the detected speed is not zero and a driving environment identified by a camera sensor or a location sensor is an urban environment.

20. The method of claim 11, wherein the controlling the radar system comprises controlling the radar sensor to operate at a maximum output for target detection when the detected speed is not zero and a driving environment identified by a camera sensor or a location sensor is not an urban environment.
